(19) United States
(12) Patent Application Publication
(10) Pub. No.: US 2024/0125276 A1
(43) Pub. Date: Apr. 18, 2024

(54) ELECTRIC MODULE

(71) Applicant: MIKUNI CORPORATION, Tokyo (JP)

(72) Inventors: Yuuhei SANEKATA, Odawara-shi, Kanagawa (JP); Keigo SUZUKI, Odawara-shi, Kanagawa (JP); Yuusaku IDE, Odawara-shi, Kanagawa (JP); Kazuo MATSUMOTO, Odawara-shi, Kanagawa (JP)

(73) Assignee: MIKUNI CORPORATION, Tokyo (JP)

(21) Appl. No.: 18/277,112

(22) PCT Filed: Mar. 17, 2021
(86) PCT No.: PCT/JP2021/010846

§ 371 Date: Aug. 14, 2023

(51) Int. Cl. F02D 9/10; F16K 37/00

(52) U.S. Cl. CPC F02D 9/1065; F02D 9/1005; F16K 37/0041

(57) ABSTRACT

Provided is an electric throttle valve 10 including: a valve body 16 including an accommodating space 19 therein and having an opening 25 that faces the accommodating space 19; a cover 11 secured to the valve body and covering the opening 25; and an electric motor 12 and a sensor 60 installed in the accommodating space 19, the cover 11 including a connector 30 for connection of a wiring between the electric motor 12 or the sensor 60 and outside, the connector 30 being installed in a desired direction with respect to the cover 11 and secured to the cover 11.

### TECHNICAL FIELD

The present invention relates to a structure of an electric module with electric equipment incorporated therein.

### BACKGROUND ART

In recent years, electric throttle valves have often been employed as throttle valves for controlling amounts of intake air of internal combustion engines mounted in vehicles, for example. Many of the electric throttle valves include electric motors, deceleration mechanisms, and throttle valves incorporated in their bodies.

Patent Document 1 discloses an example of an electric throttle valve. The electric throttle valve disclosed in Patent Document 1 has an opening in one surface of its body, and a drive shaft of an electric motor and a drive shaft of a valve are disposed substantially in parallel with an opening direction of the opening. Also, a deceleration mechanism that changes the rotational speed of the drive shaft of the electric motor and transmits the rotation to the drive shaft of the valve is disposed to be exposed from the opening of the body. Additionally, the opening of the body is covered with a cover into a tightly closed structure.

Moreover, the cover includes a connector for making an external connection of a wiring connected to internal equipment such as the electric motor. In Patent Document 1, the connector is disposed at a position near a motor gear secured to the drive shaft of the electric motor. Also, the connector is disposed to be directed to a side of the body outside the cover such that the wiring extends in a direction perpendicular to the drive shaft of the electric motor. It is thus possible to reduce the size of the entire electric throttle valve in the drive shaft direction.

### PRIOR ART DOCUMENT

### Patent Document

Patent Document 1: Japanese Patent No. 5212488

### SUMMARY OF THE INVENTION

### Problems to be Solved by the Invention

In many cases, electric throttle valves are installed in locations with limited mounting spaces such as in engine compartments of vehicles, for example, and not only installation directions of the electric throttle valves but also directions in which wirings extend from the electric throttle valves are limited. For example, in an electric throttle valve configured such that a wiring extends toward a side of a body as in Patent Document 1, there may be a need for another electric throttle valve in which a wiring connected to the connector extends in a different direction even though configurations are the same except for the connector, depending on where it is installed.

Therefore, there is a problem of increase in the types of parts needed to manufacture such an electric throttle valve with a different shape only in terms of the direction of the connector, which may lead to complication of part management.

An object of the present invention, which has been made in view of such a problem, is to provide an electric module, according to which electric modules with connectors in different directions can be manufactured from common parts.

### Means for Solving the Problems

In order to achieve the above object, an electric module according to the present invention is an electric module including: a body member including an accommodating space therein and having an opening that faces the accommodating space; a cover secured to the body member and covering the opening; and electric equipment installed in the accommodating space, the cover including a connector for connection of a wiring between the electric equipment and outside of the body member, the connector being installed in a desired direction with respect to the cover and secured to the cover.

Preferably, the connector may be secured to outside of the cover, the cover may include an opening communicating with the accommodating space at a position where the connector is secured, and the connector secured to the cover may include a connector-side terminal exposed on a side of the accommodating space from the opening and connected to the electric equipment with a wiring.

Preferably, the connector-side terminal may be linearly exposed from the opening.

Preferably, a plurality of connector-side terminals may be included in the connector and exposed to extend from the opening in parallel with each other.

Preferably, the cover may include a cover-side terminal installed to be adjacent to the connector-side terminal of the connector secured to the cover, the cover-side terminal being connected to the electric equipment, and the connector-side terminal and the cover-side terminal may be connected with a wiring.

Preferably, the electric module may be an electric throttle valve, and the electric equipment may include a motor driving a valve element and a sensor detecting a state of the electric throttle valve.

### Advantageous Effects of the Invention

According to the electric module of the present invention, it is possible to produce covers with connectors in different directions by installing the connectors in the covers and securing the connectors to the covers with the directions of the connectors changed. Therefore, it is possible to produce the covers with connectors in different directions by using the same parts.

It is thus possible to manufacture a plurality of types of electric modules with connectors in different directions with part inventory reduced in plants and the like and with places where the parts are stored reduced.

### BRIEF DESCRIPTION OF THE DRAWINGS

FIG. 1 is a side view of an electric throttle valve according to an embodiment of the present invention.

FIG. 2 is a top view of the electric throttle valve according to the present embodiment.

FIG. 3 is a top view of the electric throttle valve with a cover detached therefrom.

FIG. 4 is a vertical sectional view of an upper portion of the electric throttle valve.

FIG. 5 is a perspective view illustrating the shape of the cover before attachment of a connector.

FIG. 6 is a perspective view illustrating how to attach the connector to the cover according to another aspect.

FIG. 7 is a structure diagram of a rear surface of the cover with the connector attached thereto.

### MODE FOR CARRYING OUT THE INVENTION

Hereinafter, an embodiment of the present invention will be described on the basis of the drawings.

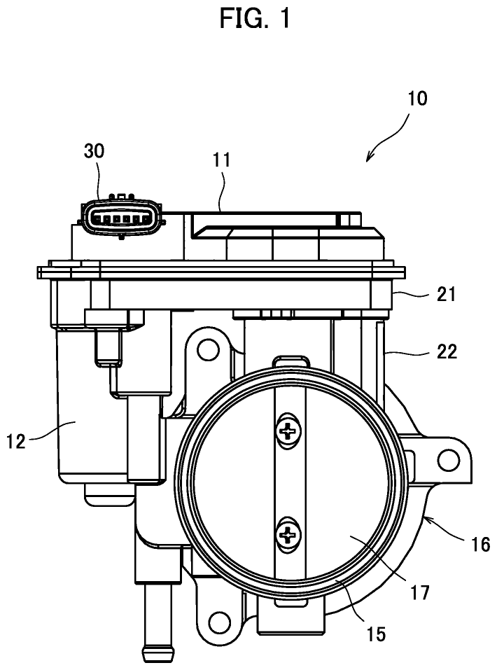

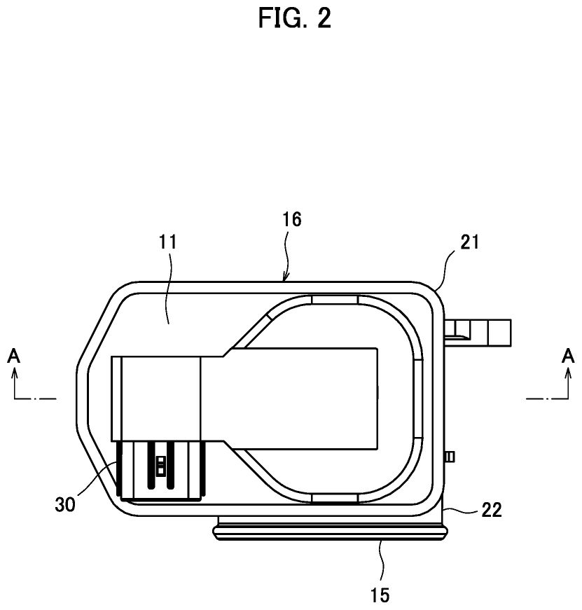

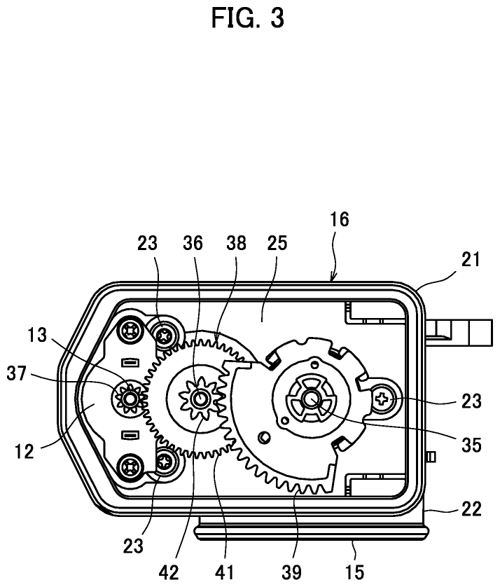

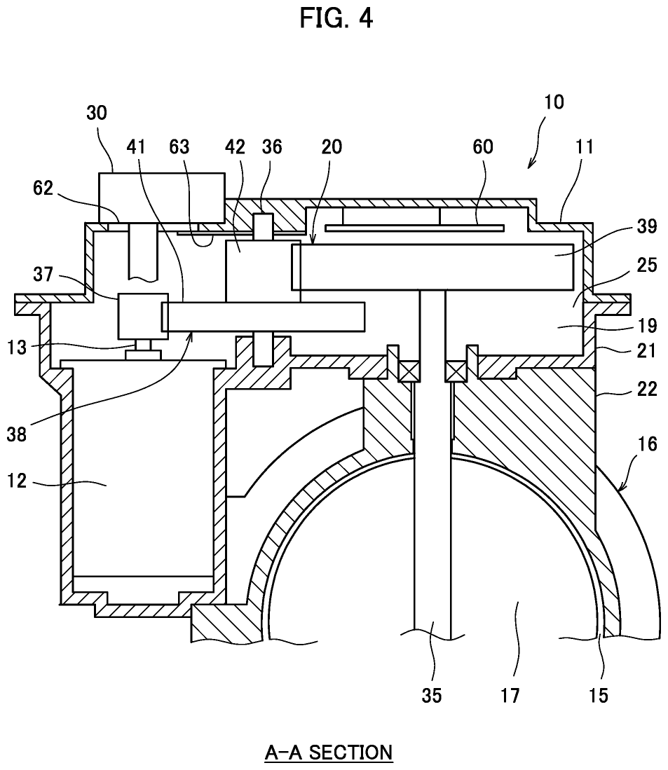

FIG. 1 is a side view of an electric throttle valve 10 (electric module) according to the embodiment of the present invention. FIG. 2 is a top view of the electric throttle valve 10 according to the present embodiment. FIG. 3 is a top view of the electric throttle valve 10 with a cover 11 detached therefrom. FIG. 4 is a vertical sectional view of an upper portion of the electric throttle valve 10. Note that FIG. 4 is a sectional view obtained by vertically cutting the upper portion of the electric throttle valve 10 in parallel with an axial direction of a motor shaft 13 which is a drive shaft of an electric motor 12 (electric equipment), which will be described later in detail. Note that the following description will be given by defining the axial direction of the motor shaft 13 as an up-down direction and using the left-right direction and the front-back direction illustrated in FIG. 1.

The electric throttle valve 10 according to the embodiment of the present invention is a fluid control valve that controls the amount of intake air of an internal combustion engine mounted in a vehicle, for example.

As illustrated in FIGS. 1 to 4, the electric throttle valve 10 includes a valve body 16 (body member) with an intake air passage 15 (fluid passage) formed therein, a valve 17 (valve element) that opens and closes the intake air passage 15 and adjusts the fluid sectional area, and an electric motor 12 that drives the valve 17.

The valve body 16 has an upper body 21 in which an accommodating space 19 with the electric motor 12 incorporated therein and a lower body 22 that includes the intake air passage 15 formed therein and is provided with the valve 17, and the valve body 16 is configured by the upper body 21 and the lower body 22 being secured to each other with a bolt 23.

The upper portion of the upper body 21 is provided with an opening 25 facing the accommodating space 19, and the opening 25 is covered with a cover 11.

Also, an inner wall of the cover 11 includes a sensor 60 (electric equipment) that detects states of the electric motor 12 and the electric throttle valve 10, such as a rotation angle sensor for detecting a rotation angle of a valve shaft 35. The cover 11 includes a wiring for supplying power to the electric motor 12 and a connector 30 for connecting a wiring connected to the sensor 60 to outside. The connector 30 is disposed above the electric motor 12 and is disposed to be directed to a side of the valve body 16, that is, perpendicularly to the axial direction of the motor shaft 13.

As illustrated in FIG. 4, the accommodating space 19 between the upper body 21 and the cover 11 accommodates a deceleration mechanism 20 (deceleration mechanism) and the electric motor 12.

The motor shaft 13 that is a drive shaft of the electric motor 12 and the valve shaft 35 that drives the valve 17 extend in the up-down direction and are disposed to be separated in parallel with each other. Upper end portions of the motor shaft 13 and the valve shaft 35 are disposed to be exposed from the opening 25 of the upper body 21. In other words, the opening 25 of the upper body 21 opens toward an extending direction of the upper end portion of the motor shaft 13.

An intermediate shaft 36 secured to the upper body 21 and the cover 11 and extending in the up-down direction in parallel with the motor shaft 13 and the valve shaft 35 is included between the motor shaft 13 and the valve shaft 35.

The deceleration mechanism 20 is configured of a motor gear 37 (input gear) secured to the upper end portion of the motor shaft 13, the intermediate shaft 36, an intermediate gear 38 rotatably supported by the intermediate shaft 36, and a valve gear 39 (output gear) secured to the upper end portion of the valve shaft 35.

The intermediate gear 38 has a first intermediate gear 41 that meshes with the motor gear 37 and a second intermediate gear 42 that meshes with the valve gear 39, and the first intermediate gear 41 and the second intermediate gear 42 are aligned and integrally configured in the up-down direction, that is, in the axial direction of the intermediate shaft 36.

The deceleration mechanism 20 decelerates and transmits a rotation drive force caused by the electric motor 12 from the motor shaft 13 to the valve shaft 35 via the motor gear 37, the first intermediate gear 41, the second intermediate gear 42, and the valve gear 39 to drive rotation, and causes the valve 17 to perform an opening or closing operation.

Note that a return spring, which is not illustrated, is included inside the upper body 21. The return spring causes the valve shaft 35 to rotate with respect to the upper body 21 and biases the valve 17 into a predetermined intermediate opening degree state, for example. Therefore, the electric throttle valve 10 serves as a constantly opening valve with the valve 17 brought into a predetermined intermediate opening degree state when the electric motor 12 stops its operation, and causes the valve 17 to perform an opening or closing operation from the predetermined intermediate opening degree by causing the electric motor 12 to operate.

In the electric throttle valve 10, the first intermediate gear 41 is disposed to be closer to the side of the electric motor 12, and the second intermediate gear 42 is disposed on the side of the cover 11, in the intermediate gear 38. Therefore, the motor gear 37 is disposed at a position close to the electric motor 12 with its position in the axial direction being aligned with that of the first intermediate gear 41, and the valve gear 39 is disposed at a position far from the valve 17 with its position in the axial direction being aligned with that of the second intermediate gear 42.

The connector 30 is secured to the upper portion of the cover 11 and is disposed above the motor gear 37.

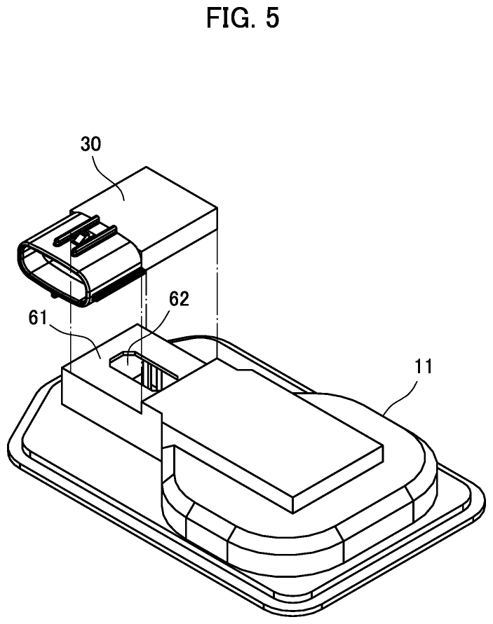

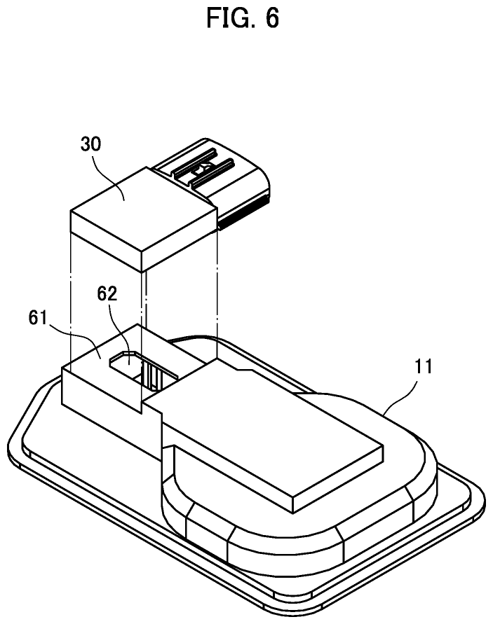

FIG. 5 is a perspective view illustrating how to attach the connector 30 to the cover 11. FIG. 6 is a perspective view illustrating how to attach the connector 30 to the cover 11 according to another aspect.

As illustrated in FIG. 5, a connector installation portion 61 that is a base for installing the connector 30 is included in the cover 11 at a location positioned above the motor gear 37. Also, an opening 62 that communicates with the accommodating space 19 is provided at the connector installation portion 61 at the position where the connector 30 is secured in the cover 11.

As illustrated in FIGS. 5 and 6, the connector 30 can be disposed at the connector installation portion 61 with the connector 30 directed in any of the forward and backward directions.

The cover 11 is formed of a material that transmits laser light, and the connector 30 is formed of a material that absorbs laser light. Additionally, the connector 30 is installed at the connector installation portion 61 with the connector 30 directed in an arbitrary direction out of the forward and backward directions with respect to the cover 11, and the cover 11 and the connector 30 are welded by a laser device irradiating the connector installation portion 61 with laser light from the rear surface (lower surface) of the cover 11.

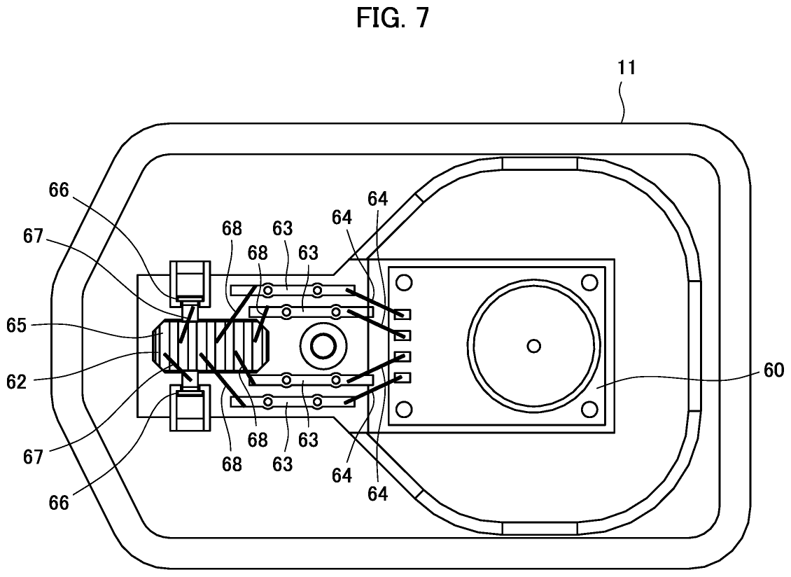

FIG. 7 is a structure diagram of the rear surface (inner wall surface) of the cover 11 with the connector 30 attached thereto.

As illustrated in FIG. 7, a plurality of sensor connecting terminals 63 (cover-side terminals) extending from sides (the front side and the rear sides) of the opening 62 toward the sensor 60 provided inside the cover 11 are secured to the rear surface of the connector installation portion 61 of the cover 11. End portions of the sensor connecting terminals 63 on the side of the sensor 60 and the sensor 60 are connected with leads 64.

A lower surface of the connector 30 includes a plurality of connector-side terminals 65 for connecting wirings to the electric motor 12 and the sensor 60. The connector terminals are formed into a linear shape and are disposed at the connector 30 at intervals therebetween in parallel with each other. The plurality of connector-side terminals 65 are disposed to extend in the front-back direction at intervals therebetween in the left-right direction and be exposed from the opening 62 when the connector 30 is installed at the connector installation portion 61. Therefore, the plurality of connector-side terminals 65 are adapted to be at least partially exposed from the opening 62 regardless of which of the forward direction and the backward direction the connector 30 is directed and disposed with respect to the cover 11.

Also, the rear surface (inner wall surface) of the connector installation portion 61 of the cover 11 includes motor connecting terminals 66 (cover-side terminals) extending downward from the position adjacent to the opening 62. The lower end portions of the motor connecting terminals 66 are configured to be connected to the electric motor 12 when the cover 11 is attached to the valve body 16.

Leads 68 are connected to end portions of the sensor connecting terminals 63, and leads 67 are connected to upper end portions of the motor connecting terminals 66, for each of the connector-side terminals 65 exposed from the opening 62.

When the electric throttle valve 10 is assembled, the connector 30 is installed at the connector installation portion 61 with the connector 30 directed in a desired direction out of the front and back directions with respect to the cover 11, and the laser device or the like irradiates the connector installation portion 61 with laser light from the rear surface (lower surface) of the cover 11 to weld the cover 11 and the connector 30.

Also, the sensor 60, the sensor connecting terminals 63, and the motor connecting terminals 66 are installed in the cover 11, the leads 67 and 68 are connected to the connector-side terminals 65 exposed from the opening 62 of the cover 11, and a cover unit 70 is thereby manufactured.

The assembly of the electric throttle valve 10 is completed by installing the electric motor 12, the deceleration mechanism 20, and the like in the accommodating space 19 of the valve body 16 in which the lower body 22 and the upper body 21 are connected, then covering the opening 25 at the upper portion of the upper body 21 with the cover unit 70, and welding and securing the upper body 21 and the cover 11 with the laser device, for example.

As described above, the electric throttle valve 10 incudes the connector 30 for making an external connection of the wirings connected to the electric motor 12 and the sensor 60. The connector 30 is installed at the connector installation portion 61 of the cover 11, and the connector 30 is welded to the cover 11 by the laser device or the like, and the cover 11 is thereby manufactured. It is possible to manufacture the cover 11 with the connector 30 in a different direction by installing the connector 30 with its direction changed in the cover 11 and performing welding thereon. Therefore, it is possible to produce the electric throttle valve 10 with the connector 30 directed forward as illustrated in FIGS. 1, 2, and 5, for example, and an electric throttle valve with the connector 30 directed backward as illustrated in FIG. 6, by using the same parts. Alternatively, the connector 30 may be installed in a desired direction within a range of 180 degrees between the front and back directions (within the range of 180 degrees between the upward direction and the downward direction including the left side on the paper surface in FIG. 2).

In this manner, it is possible to produce a plurality of types of electric throttle valves with the connectors 30 directed in different directions within the range of 180 degrees in the forward direction and the backward direction or on the left side while reducing the types of parts. It is thus possible to reduce part inventory in plants and the like and to reduce places where the parts are stored.

The connector installation portion 61 provided on the upper surface of the cover 11 is provided with the opening 62, the lower surface of the connector 30 is provided with the connector-side terminals 65, and the connector-side terminals 65 are exposed from the opening 62 when the connector 30 is secured to the cover 11.

On the other hand, the motor connecting terminals 66 connected to the electric motor 12 and the sensor connecting terminals 63 connected to the sensor 60 are provided on the inner wall surface of the cover 11. It is thus possible to electrically connect the electric motor 12, the sensor 60, and the like inside the accommodating space 19 to the connector 30 in an easy manner by connecting the motor connecting terminals 66 to the connector-side terminals 65 with the leads 67 and connecting the sensor connecting terminals 63 to the connector-side terminals 65 with the leads 68 through soldering, for example.

Also, since end portions of the motor connecting terminals 66 and the sensor connecting terminals 63 on one side are disposed to be adjacent to the opening 62 in the cover 11, it is possible to shorten the leads 67 and 68 and to simplify the configuration in the accommodating space 19.

Particularly, since the connector-side terminals 65 are formed into a linear shape, it is possible to connect the leads 67 and 68 to arbitrary positions of the connector-side terminals 65 linearly exposed from the opening 62. Also, in cases where the connector 30 is secured to the cover 11 in mutually different directions, the linear exposure of the connector-side terminals 65 from the opening 62 in any of the cases always enables easy connection of the leads 67 and 68 to the connector-side terminals 65. In a case where two types of covers with the connectors 30 inverted by 180 degrees in the covers 11 as in FIGS. 5 and 6 are needed, for example, it is possible to connect the leads 67 and 68 to the connector-side terminals 65 at arbitrary positions in the front-back direction within the range of the opening 62 by configuring the connector-side terminals 65 to extend in the front-back direction (the up-down direction in FIG. 7) which is a direction perpendicular to an inversion reference line (the line extending in the left-right direction in FIG. 7). Therefore, it is possible to easily connect the leads 67 and 68 while avoiding intersection of the plurality of leads 67 and 68 provided and to establish the connection with the simple structure.

Although the description of the embodiment will end here, aspects of the present invention are not limited to the above embodiment. Detailed shapes of components in the electric throttle valve 10 in the above embodiment may be different in appropriate manners. For example, the shape of the connector-side terminals 65 may not be a straight line shape as illustrated in FIG. 7 and may be various shapes such as a bent shape like an L shape.

Also, although the present invention has been applied to the electric throttle valve 10 in the above embodiment, the present invention can be widely applied to electrically controlled valves for other applications or electric units other than the electrically controlled valves.

### EXPLANATION OF REFERENCE SIGNS

10 Electric throttle valve (electric module)
11 Cover
12 Electric motor (electric equipment)
16 Valve body (body member)
17 Valve (valve element)
19 Accommodating space
21 Upper body
25 Opening
30 Connector
60 Sensor (electric equipment)
62 Opening
65 Connector-side terminal
63 Sensor connecting terminal (cover-side terminal)
66 Motor connecting terminal (cover-side terminal)

1. An electric module comprising:
a body member including an accommodating space therein and having an opening that faces the accommodating space;
a cover secured to the body member and covering the opening; and
electric equipment installed in the accommodating space,
wherein the cover includes a connector for connection of a wiring between the electric equipment and outside of the body member, and
the connector is installed in a desired direction with respect to the cover and is secured to the cover.

2. The electric module according to claim 1,
wherein the connector is secured to outside of the cover,
the cover includes an opening communicating with the accommodating space at a position where the connector is secured, and
the connector secured to the cover includes a connector-side terminal exposed on a side of the accommodating space from the opening and connected to the electric equipment with a wiring.

3. The electric module according to claim 2, wherein the connector-side terminal is linearly exposed from the opening.

4. The electric module according to claim 3, wherein a plurality of the connector-side terminals are included in the connector and are exposed to extend from the opening in parallel with each other.

5. The electric module according to claim 4,
wherein the cover includes a cover-side terminal installed to be adjacent to the connector-side terminal of the connector secured to the cover, the cover-side terminal being connected to the electric equipment, and
the connector-side terminal and the cover-side terminal are connected with a wiring.

6. The electric module according to claim 4,
wherein the electric module is an electric throttle valve, and
the electric equipment includes a motor driving a valve element and a sensor detecting a state of the electric throttle valve.
